(19) United States
(12) Patent Application Publication
(10) Pub. No.: US 2016/0048858 A1
(43) Pub. Date: Feb. 18, 2016

(54) METHOD AND SYSTEM FOR DYNAMICALLY CREATING MICRONEIGHBORHOOD AUDIENCE SEGMENTS

(71) Applicant: MasterCard International Incorporated, Purchase, NY (US)

(72) Inventors: Serge BERNARD, Danbury, CT (US); Po Hu, Norwalk, CT (US); Nikhil Malgatti, Stamford, CT (US)

(73) Assignee: MASTERCARD INTERNATIONAL INCORPORATED, Purchase, NY (US)

(21) Appl. No.: 14/458,726

(22) Filed: Aug. 13, 2014

(51) Int. Cl. G06Q 30/02

(52) U.S. Cl. CPC G06Q 30/0205

(57) ABSTRACT

A method for generating a micro-neighborhood of consumers includes: storing a plurality of account profiles, each profile including data related to a consumer including account data, a micro-neighborhood location identifier, and a plurality of transaction data entries, each entry being related to a payment transaction involving the related consumer and including transaction data; scoring each account profile stored in the account database by application of a scoring model to the transaction data included in one or more transaction data entries included in the respective account profile; and identifying a plurality of account profile groupings, each grouping including a subset of the plurality of account profiles identified based on the score for and micro-neighborhood location identifier included in each account profile included in the subset, wherein the subset of the plurality of account profiles included in each account profile grouping includes at least a predetermined number of account profiles.

### FIELD

The present disclosure relates to the creation of a micro-neighborhood of consumers, specifically the use of transaction data to group consumers located in relatively close proximity to each other in micro-neighborhoods based on the proximity and purchase behavior scoring.

### BACKGROUND

Consumers are often grouped together in any number of ways for any number of reasons. For instance, merchants, advertisers, content providers, and other entities may group consumers together for the purposes of targeting or for content distribution. In one example, consumers may be grouped into microsegments based on commonality in demographic characteristics associated with the consumers in each group. Microsegments may maintain consumer privacy and security, while providing sufficient granularity to be useful to merchants and advertisers. Additional detail regarding microsegments can be found in U.S. patent application Ser. No. 13/437,987, entitled “Protecting Privacy in Audience Creation,” by Curtis Villars et al., filed on Apr. 3, 2012, which is herein incorporated by reference in its entirety.

Microsegments, like other methods for grouping consumers, are often based on a broad or a narrow metric. For example, microsegments group consumers together based on their demographic characteristics, and the greater the number of data points or the uniqueness of the data points between the total population being reviewed, the smaller the segments can become. Smaller groups or microsegments is usually viewed and providing more powerful analytic ability, and there is a pressure to find new but meaningful ways to separate people or other entities into smaller, more defined groups.

Thus, there is a need for a technical solution that combines the granularity and privacy of microsegments with the strength and value of spending behavior as a grouping metric in small but meaningfully defined groups.

### SUMMARY

The present disclosure provides a description of systems and methods for generating a micro-neighborhood of consumers.

A method for generating a micro-neighborhood of consumers includes: storing, in an account database, a plurality of account profiles, wherein each account profile includes data related to a consumer including at least account data, a micro-neighborhood location identifier, and a plurality of transaction data entries, each transaction data entry being related to a payment transaction involving the related consumer and including at least transaction data; scoring, by a processing device, each account profile stored in the account database by application of a scoring model to at least the transaction data included in one or more transaction data entries included in the respective account profile; and identifying, by the processing device, a plurality of account profile groupings, wherein each account profile grouping includes a subset of the plurality of account profiles identified based on at least the score for and micro-neighborhood location identifier included in each account profile included in the subset, wherein the subset of the plurality of account profiles included in each account profile grouping includes at least a predetermined number of account profiles.

A system for generating a micro-neighborhood of consumers includes an account database and a processing device. The account database is configured to store a plurality of account profiles, wherein each account profile includes data related to a consumer including at least account data, a micro-neighborhood location identifier, and a plurality of transaction data entries, each transaction data entry being related to a payment transaction involving the related consumer and including at least transaction data. The processing device is configured to: score each account profile stored in the account database by application of a scoring model to at least the transaction data included in one or more transaction data entries included in the respective account profile; and identify a plurality of account profile groupings, wherein each account profile grouping includes a subset of the plurality of account profiles identified based on at least the score for and micro-neighborhood location identifier included in each account profile included in the subset. The subset of the plurality of account profiles included in each account profile grouping includes at least a predetermined number of account profiles.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the generating of micro-neighborhoods of consumers in accordance with exemplary embodiments.

FIG. 2 is a block diagram illustrating the processing server of FIG. 1 for the generating of consumer micro-neighborhoods in accordance with exemplary embodiments.

FIG. 3 is a flow diagram illustrating a process for generating consumer micro-neighborhoods using the processing server of FIG. 2 in accordance with exemplary embodiments.

FIG. 4 is a diagram illustrating the generating of multiple micro-neighborhoods using purchase and location data in accordance with exemplary embodiments.

FIG. 5 is a flow chart illustrating an exemplary method for generating a micro-neighborhood of consumers in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Micro-neighborhoods of consumers—A grouping or cluster of consumers based on similar behavior (e.g., spending pattern) and location data that has a granularity greater than standard zip codes or recognized governmental boundaries (e.g., extended zip codes, blocks on a street, etc.).

Geographic location—A geographic location may be represented by an extended zip code or similar postal code, within a sequence of street addresses, limited range around set of coordinates (e.g., latitude and longitude) that produces a group or microsegment of a limited number of consumers (e.g., 10 to 50, for example, depending on the intended use of the data), or any another representation of an area of consumers that may encompass individual consumers, without the number of consumers being so limited that the data would personally identify an individual consumer. For example, the geographic location may be a circular area of a specific radius (e.g., one mile or less) centered on coordinates such that the circular area encompasses the location of the consumer. The location of the consumer 102 may be the consumer's residence, mailing address, transaction centroid, or other suitable manner of representation of a consumer location.

### System for Generating Micro-Neighborhoods of Consumers

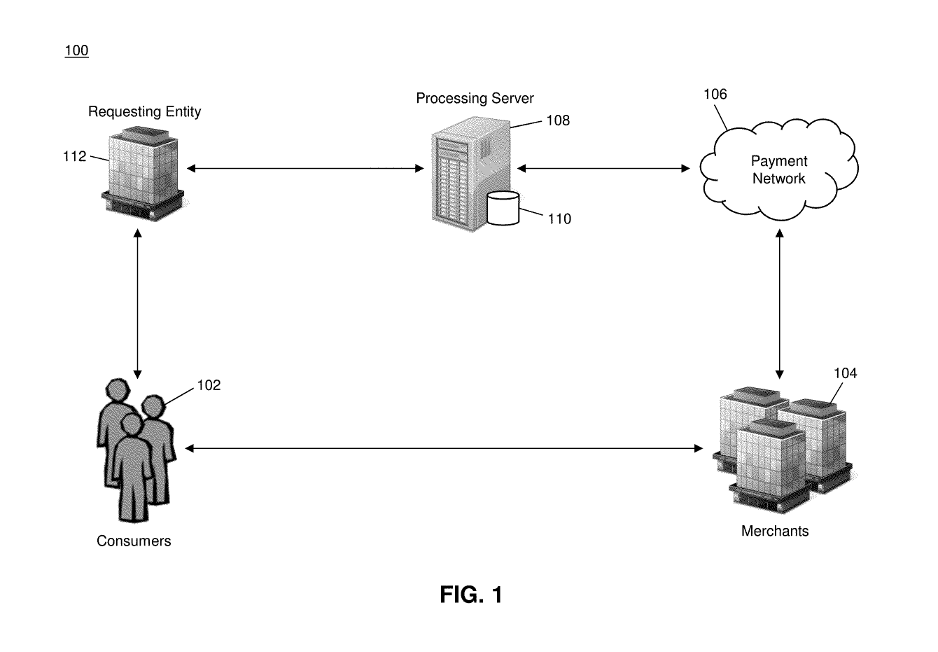

FIG. 1 illustrates a system 100 for the generating of micro-neighborhoods of consumers using purchase and location data.

The system 100 may include a plurality of consumers 102. Each consumer 102 may conduct one or more payment transactions at one or more merchants 104. The payment transactions may be processed by a payment network 106 using methods and systems that will be apparent to persons having skill in the relevant art. As part of the transaction processing, the payment network 106 may provide transaction data for each of the processed payment transactions to a processing server 108.

The processing server 108, discussed in more detail below, may be configured to store the received transaction data in an account database 110, separated into different accounts, each associated with the consumer 102 involved in the respective transaction. The processing server 108 may be further configured to separate the consumers 102 into micro-neighborhoods using methods and systems discussed in more detail below. Each micro-neighborhood may include consumers 102 that are grouped based on a geographic location and a behavioral score.

The behavioral score may be a score calculated for each consumer 102 for one or more specific purchasing metrics, which may be calculated via the application of one or more scoring algorithms to the transaction data for payment transactions involving the consumer 102 and stored in an account database 110. The behavioral score may be a score indicative of the respective consumer's 102 likelihood to conduct a payment transaction or otherwise fulfill criteria associated with the scoring, calculated based on the consumer's past transaction history.

For example, the processing server 108 may calculate a score for a consumer's propensity to purchase a smart phone in the next thirty days, to shop at a particular merchant during a period of time, to spend at least a specified amount on a specific type of product or industry, to purchase a type or specific product or service by a given time or during a given period of time, etc. Additional types of purchase behavior and spending behavior for which a consumer score may be calculated using the respective consumer's past transaction data will be apparent to persons having skill in the relevant art.

The processing server 108 may group consumers 102 together into micro-neighborhoods of consumers based on their geographic location and their calculated score. For example, the processing server 108 may group together all consumers 102 who are associated with a specific extended zip code and who have a score at or above a specific level. It will be apparent to persons having skill in the relevant art that consumers 102 may be included in a plurality of different micro-neighborhoods, such as a different micro-neighborhood for each of a plurality of different transaction behaviors.

In some embodiments, the system 100 may also include a requesting entity 112. The requesting entity 112 may be an entity, such as a merchant or advertisers, that may request a micro-neighborhood of consumers 102, or data based thereon, from the processing server 108. For instance, a merchant the requesting entity 112 may request micro-neighborhoods of consumers 102 in a specified geographic area that are grouped based on their propensity to shop at the merchant in the next thirty days. The processing server 108 may identify micro-neighborhoods of consumers 102 accordingly, and provide the data to the requesting entity 112.

The use of micro-neighborhoods to group consumers may be beneficial to both content providers and the consumers themselves. For example, content providers may receive more valuable data as they may be able to identify consumers who have a high likelihood to spend in a desirable category, and may also be able to identify a small area where they are located for more effective targeting. At the same time, the consumers 102 in the micro-neighborhoods will be able to receive more effective, and thus more efficient and better for the consumer 102, targeting by way of the micro-neighborhoods, without sacrificing privacy or security.

### Processing Server

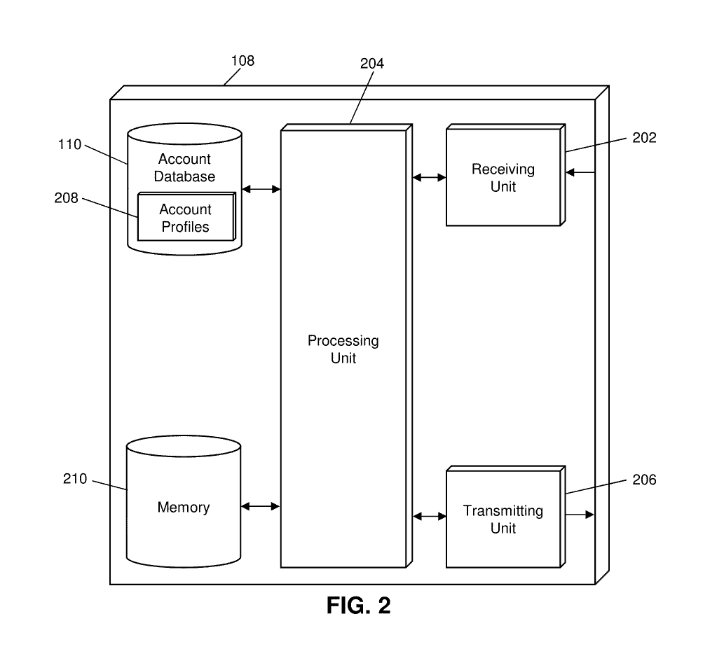

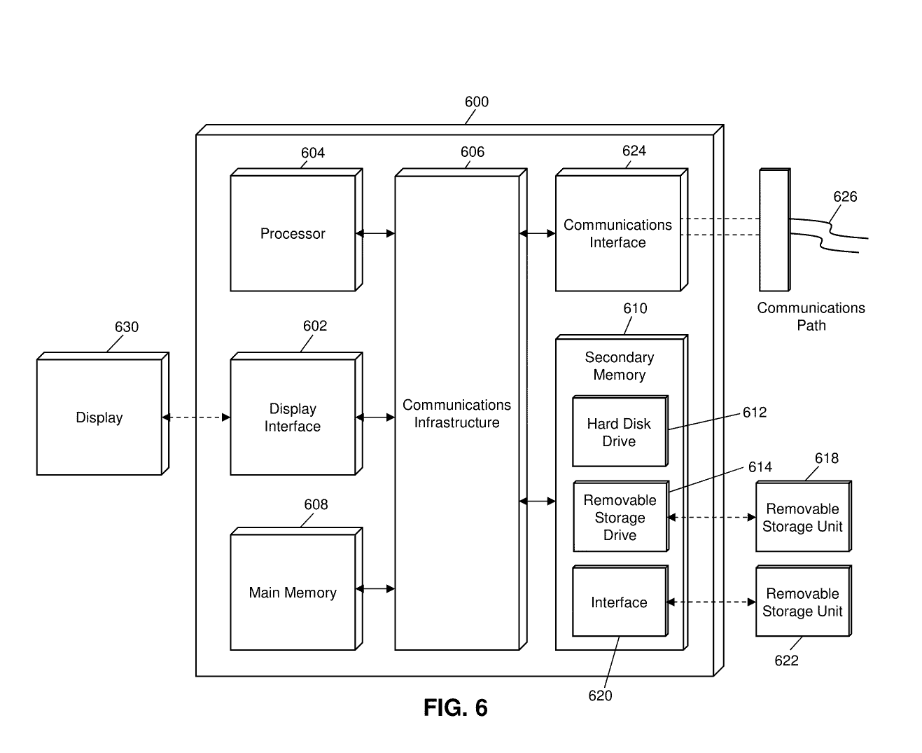

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 600 illustrated in FIG. 6 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive transaction data from the payment network 106, which may be stored in the account database 110. The receiving unit 202 may also receive data requests from the requesting entity 112, such as requests for micro-neighborhood data, requests for account profiles, etc. The data requests received by the receiving unit 202 may include scoring criteria, target demographics, geographic locations, or other data as provided by the requesting entity 112 for obtaining specific data based on generated micro-neighborhoods.

The processing server 108 may also include a processing unit 204. The processing unit 204 may be configured to perform the functions of the processing server 108 discussed herein as will be apparent to persons having skill in the relevant art. The processing unit 204 may store transaction data received from the payment network 106 in the account database 110 in a plurality of account profiles 208. Each account profile 208 may include account data, a location identifier, and a plurality of transaction data entries, with each transaction data entry being related to a payment transaction involving a consumer 102 related to the account profile 208 and including transaction data.

The account data may include consumer demographic information, consumer preferences, and any other suitable type of data associated with the related consumer 102 as will be apparent to persons having skill in the relevant art. In some embodiments, the account data may not include any personally identifiable information for the related consumer 102 without consent from the related consumer 102. The location identifier may be a value indicative of the geographic location of the related consumer 102, such as a micro-neighborhood location identifier, which may be an extended zip code, street address and radius, postal code, geographic coordinate and radius, or any other value suitable for indicating the geographic location of a consumer 102 without being personally identifiable.

The transaction data included in each transaction data entry in the account profiles 208 may include transaction amounts, product data, merchant data, transaction times and/or dates, geographic locations, point of sale data, consumer data, offer redemption data, and/or any other suitable type of data associated with a payment transaction that may be suitable for performing the functions disclosed herein as will be apparent to persons having skill in the relevant art. For example, the transaction data may include merchant industry information and merchant identifiers associated with a merchant 104 involved in the payment transaction, such as for use in generating a score for the related consumer 102 for the corresponding purchase behavior (e.g., likelihood to shop at the merchant 104 or in the same industry).

The processing unit 204 may be further configured to score each account profile 208 stored in the account database 110 by application of a scoring model to the transaction data included in one or more transaction data entries stored in the respective account profile 208. In some embodiments, the processing unit 204 may also be configured to generate the scoring model used to calculate the score for each account profile 208, such as based on criteria received by the receiving unit 202 from the requesting entity 112 or other source, such as a user of a computing device in communication with the processing server 108. Methods and systems for generating a scoring model based on provided criteria will be apparent to persons having skill in the relevant art.

The scoring model or models used to score account profiles 208 based on transaction data may be stored in a memory 210 of the processing server 108. The memory 210 may be configured to store data suitable for use in performing the functions disclosed herein, such as the scoring models, program code executable by the processing unit 204 for performing the functions disclosed herein, rules regarding the generation of micro-neighborhoods, and additional data that will be apparent to persons having skill in the relevant art.

The processing unit 204 of the processing server 108 may also be configured to identify one or more groupings of account profiles 208, which may be referred to as micro-neighborhoods. Each micro-neighborhood may include a subset of the account profiles 208 and may be based on a combination of the score for the respective account profile 208 and the location identifier included in the respective account profile 208. For example, micro-neighborhoods may include account profiles 208 that have the same location identifier and a score within a predetermined range. In some instances, the grouping may be based on use of one or more optimization algorithms, for the optimization of the combination of the score and location identifier. In one embodiment, the optimization may take a distance between each account profile 208 in a grouping into account based on the included location identifier.

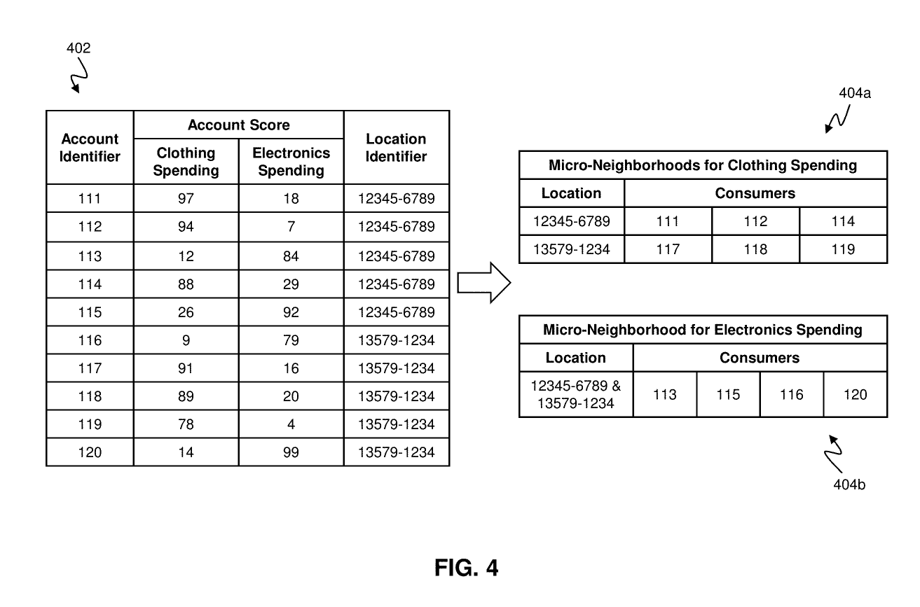

In some embodiments, each micro-neighborhood or grouping of account profiles 208 may include at least a predetermined number of account profiles. The predetermined number may be such that the account profiles 208 included in the respective micro-neighborhood are not personally identifiable. In some instances, a grouping of account profiles 208 may include multiple location identifiers, such as to accommodate the predetermined number of account profiles, as illustrated in FIG. 4 and discussed in more detail below.

The processing server 108 may further include a transmitting unit 206. The transmitting unit 206 may be configured to transmit data over one or more networks via one or more network protocols. The transmitting unit 206 may be configured to transmit data requests to the payment network 106 (e.g., for transaction data), account profile 208 data or micro-neighborhood data to the requesting entity 112 (e.g., in response to a received data request), or other data transmissions that will be apparent to persons having skill in the relevant art.

### Process for Generating Micro-Neighborhoods of Consumers

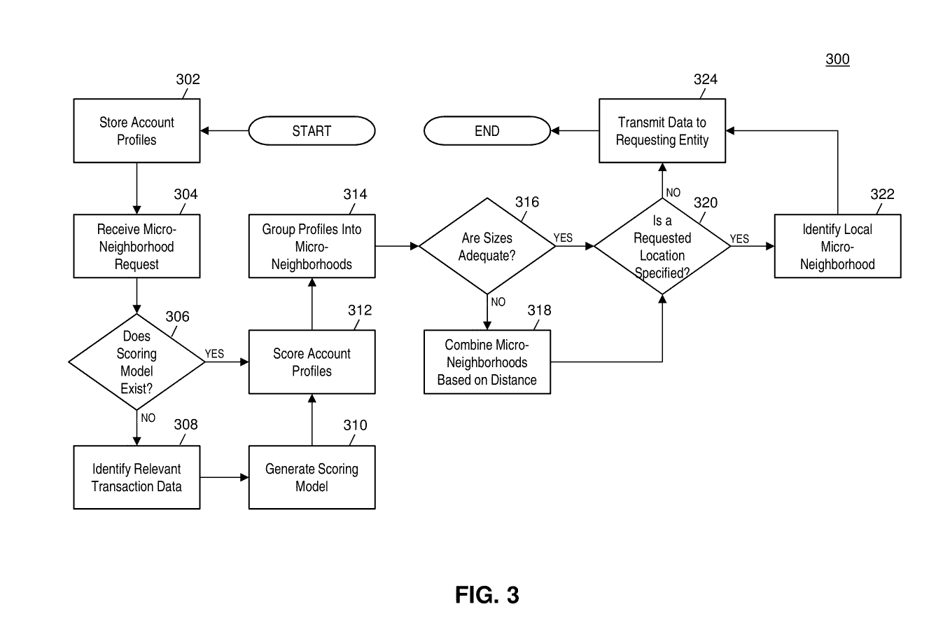

FIG. 3 illustrates a process 300 for the generating of micro-neighborhoods of consumers 102 based on purchase behavior and geographic location using the processing server 108.

In step 302, the processing unit 204 of the processing server 108 may store a plurality of account profiles 208 in the account database 110. Each account profile 208 may include data related to a consumer 102 including at least account data, a location identifier, and a plurality of transaction data entries, each transaction data entry being related to a payment transaction involving the related consumer and including at least transaction data. In step 304, the receiving unit 202 of the processing server 108 may receive a micro-neighborhood request from the requesting entity 112. The micro-neighborhood request may include a spending behavior for which a micro-neighborhood is requested.

In step 306, the processing unit 204 may identify if a scoring model for the indicated spending behavior already exists (e.g., stored in the memory 210). For example, the processing server 108 may have previously generated the scoring model as part of a different request, or as part of the preparation of the processing server 108 in anticipation of micro-neighborhood requests. If no such model exists, then, in step 308, the processing unit 204 may identify transaction data in one or more account profiles 208 relevant to the spending behavior. For example, if the spending behavior is the propensity for consumers 102 to shop at a particular merchant 104, the identified transaction data may be transaction data for payment transactions involving the particular merchant 104.

Once the transaction data has been identified, then, in step 310, the processing unit 204 may generate a scoring model to score account profiles 208 for the spending behavior using the identified transaction data. Once a scoring model for the spending behavior has been generated, or if a suitable pre-existing scoring model was identified in step 306, then, in step 312, the processing unit 204 may score the account profiles 208 by application of the scoring model to the transaction data of one or more transaction data entries included in the respective account profile 208. In some instances, the score may also be based on the account data included in the respective account profile 208. For example, a score may be affected by preferences provided by the consumer 102, or by demographic data associated with the consumer 102. For instance, a female consumer 102 may be more likely to purchase makeup than a male consumer 102 regardless of past transaction history, which may affect the score.

In step 314, the processing unit 204 may group the account profiles 208 into micro-neighborhoods based on the score calculated for each account profile 208 and the location identifier included in each account profile 208. In step 316, the processing unit 204 may determine if the sizes of each micro-neighborhood are adequate, such as by identifying if the number of account profiles 208 in each micro-neighborhood is at least a predetermined number of account profiles 208. For example, each micro-neighborhood may need to include at least ten account profiles 208 in order to maintain a high level of consumer privacy.

If a micro-neighborhood does not have a sufficient number of account profiles 208 included, then, in step 318, the processing unit 204 may combine the micro-neighborhood with one or more other micro-neighborhoods based on distance from the location identifier of the first micro-neighborhood with the location identifier of the one or more other micro-neighborhoods being combined into the first. For instance, the processing unit 204 may combine two micro-neighborhoods that are situated next to each other (e.g., neighboring extended zip codes). The number of micro-neighborhoods combined may be such that the resulting number of account profiles 208 included in the combined micro-neighborhood meets or exceeds the predetermined number required to maintain a high level of consumer privacy.

Once the micro-neighborhoods have been identified and are of adequate sizes, then, in step 320, the processing unit 204 may determine if the received micro-neighborhood request specifies a geographic location or area. If one is specified, then, in step 322, the processing unit 204 may identify one or more local micro-neighborhoods that are included at the geographic location or within the geographic area specified in the request. For example, the requesting entity 112 may request the highest scoring micro-neighborhood for a specific geographic location, may request the highest scoring micro-neighborhoods for each location identifier in a geographic area, may request all micro-neighborhoods in a geographic area, etc. If, at step 320, the processing unit 204 determines that the received micro-neighborhood request does not specific a geographic location or area, then step 322 may not be required and the process 300 may continue to step 324.

In step 324, the transmitting unit 206 of the processing server 108 may transmit the identified micro-neighborhoods to the requesting entity 112. In some embodiments, the transmission to the requesting entity 112 may include the account data included in each of the account profiles 208 included in the respective micro-neighborhood. In other embodiments, the transmission may include only specific data included in each of the account profiles 208, such as specifically requested by the requesting entity 112 and/or identified by the processing unit 204. For example, the transmitting unit 206 may provide non-personally identifiable demographic information for the consumers 102 included in each micro-neighborhood to the requesting entity 112.

### Generating of Micro-Neighborhoods

FIG. 4 illustrates an example generation of micro-neighborhoods of consumers based on purchase behavior scoring and geographic locations.

FIG. 4 includes a table 402. The table 402 includes a plurality of rows, each of which may correspond to an account profile 208 stored in the account database 110. Each row includes an account identifier, which may be a value indicative of the related account profile 208 and may be used for identification of an account profile 208. For example, in some embodiments, the account identifier may be a payment account number or part thereof, a username, e-mail address, telephone number, etc. In the example illustrated in FIG. 4, the account identifier is a three-digit identification number.

Each row may also include a location identifier, which may be the location identifier included in the associated account profile 208. In the example illustrated in FIG. 4, the location identifier may be an extended zip code. Each of the rows also includes two scores that have been calculated for the associated account profile 208. The left score is a score regarding the account profile's 208 spending behavior for clothing on a scale of 1 to 100, with a higher score indicating a higher propensity to purchase clothing. The right score is a score regarding the account profile's 208 spending behavior for electronics on the scale of 1 to 100, with a higher score indicating a higher propensity to purchase electronics.

Using the methods and systems discussed herein, the processing unit 204 of the processing server 108 may be configured to generate micro-neighborhoods from the data included in the table 402. As illustrated in FIG. 4, the processing server 108 may generate micro-neighborhoods for locations that include account profiles 208 with a score of at least 75. In addition, in the illustrated example, the predetermined number of account profiles that must be included in a micro-neighborhood is three. Accordingly, the processing server 108 may generate two micro-neighborhoods for clothing spending and a combined micro-neighborhood for electronics spending, illustrated in the tables 404a and 404b, respectively.

The first micro-neighborhood for clothing spending, illustrated in table 404a, includes account profiles 208 with scores above 75 that are located in the extended zip code 12345-6789. The second micro-neighborhood for clothing spending includes account profiles 208 with scores above 75 located in the extended zip code 13579-1234. For electronics spending, each of the two location identifiers 12345-6789 and 13579-1234 only include two account profiles 208 with scores above 75. As such, the processing server 108 may combine the two micro-neighborhoods into a single micro-neighborhood, illustrated in table 404b, in order to satisfy the requirement that each micro-neighborhood includes at least a minimum number of account profiles 208 that assure that the consumer cannot be personally identified.

### Exemplary Method for Generating a Micro-Neighborhood of Consumers

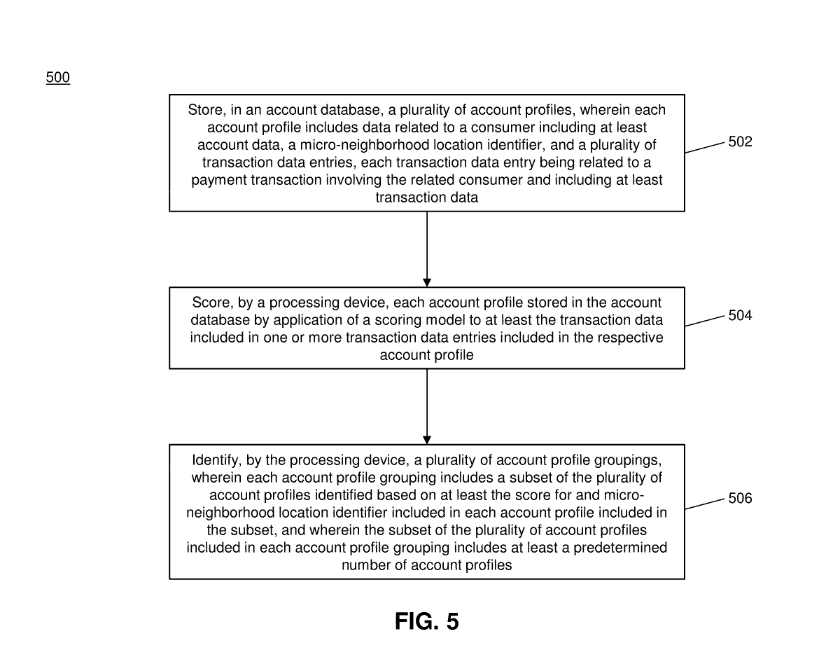

FIG. 5 illustrates a method 500 for the generation of a micro-neighborhood of consumers based on purchase behavior scoring and geographic location.

In step 502, a plurality of account profiles (e.g., account profiles 208) may be stored in an account database (e.g., the account database 110), wherein each account profile 208 includes data related to a consumer (e.g., the consumer 102) including at least account data, a micro-neighborhood location identifier, and a plurality of transaction data entries, each transaction data entry being related to a payment transaction involving the related consumer 102 and including at least transaction data. In some embodiments, the micro-neighborhood location identifier may be at least one of: an extended zip code, a radius of a mile or less around a given latitude and longitude, and a plurality of blocks on one or more adjacent streets. In one embodiment, each account profile 208 may not include any personally identifiable information.

In step 504, each account profile 208 stored in the account database 110 may be scored by a processing device (e.g., the processing unit 204) by application of a scoring model to at least the transaction data included in one or more transaction data entries included in the respective account profile 208. In one embodiment, the score for each account profile 208 may indicate a propensity for the related consumer 102 to spend for one or more of a plurality of spend criteria.

In step 506, a plurality of account profile groupings may be identified by the processing device 204, wherein each account profile grouping includes a subset of the plurality of account profiles 208 identified based on at least the score for and micro-neighborhood location identifier included in each account profile 208 included in the subset, and wherein the subset of the plurality of account profiles 208 included in each account profile grouping includes at least a predetermined number of account profiles 208. In some embodiments, the predetermined number of account profiles 208 is a minimum number of account profiles 208 such that no account profile 208 included in the account profile grouping is personally identifiable to a consumer 102.

In one embodiment, identifying the plurality of account profile groupings may be further based on an application of one or more optimization algorithms to the score for each account profile 208 included in the subset and a distance between each account profile 208 included in the subset based on the included micro-neighborhood location identifier. In some embodiments, the method 500 may further include: generating, by the processing device 204, the scoring model based on the transaction data included in one or more transaction data entries included in one or more account profiles 208 stored in the account database 110.

In one embodiment, the method 500 may also include: receiving, by a receiving device (e.g., the receiving unit 202), a request for a consumer group, wherein the request for a consumer group includes at least a spending behavior; identifying, by the processing device 204, the scoring model based on the spending behavior; and transmitting, by a transmitting device (e.g., the transmitting unit 206), at least the account data included in each account profile 208 included in the subset of account profiles 208 included in at least one account profile grouping. In a further embodiment, the request for a consumer group may further include a geographic location, and the at least one account profile grouping may be based on the geographic location and the micro-neighborhood location identifier included in each account profile 208 included in the subset of account profiles 208 included in the at least one account profile grouping. In another further embodiment, the method 500 may even further include generating, by the processing device 204, the scoring model based on the spending behavior included in the received request for a consumer group and the transaction data included in one or more transaction data entries included in one or more account profiles 208 stored in the account database 110.

### Computer System Architecture

FIG. 6 illustrates a computer system 600 in which embodiments of the present disclosure, or portions thereof, may be implemented as computer-readable code. For example, the processing server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein.

Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for generating a micro-neighborhood of consumers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating a micro-neighborhood of consumers, comprising:
storing, in an account database, a plurality of account profiles, wherein each account profile includes data related to a consumer including at least account data, a micro-neighborhood location identifier, and a plurality of transaction data entries, each transaction data entry being related to a payment transaction involving the related consumer and including at least transaction data;
scoring, by a processing device, each account profile stored in the account database by application of a scoring model to at least the transaction data included in one or more transaction data entries included in the respective account profile; and
identifying, by the processing device, a plurality of account profile groupings, wherein each account profile grouping includes a subset of the plurality of account profiles identified based on at least the score for and micro-neighborhood location identifier included in each account profile included in the subset,
wherein the subset of the plurality of account profiles included in each account profile grouping includes at least a predetermined number of account profiles.

2. The method of claim 1, wherein identifying a plurality of account profile groupings based on at least the score for and micro-neighborhood location identifier included in each account profile included in the subset is further based on application of one or more optimization algorithms to the score for each account profile included in the subset and a distance between each account profile included in the subset based on the included micro-neighborhood location identifier.

3. The method of claim 1, wherein the micro-neighborhood location identifier is at least one of: an extended zip code, radius of a mile or less around a given latitude and longitude, and a plurality of blocks on one or more adjacent streets.

4. The method of claim 1, wherein the predetermined number of account profiles is a minimum number of account profiles such that no account profile included in the account profile grouping is personally identifiable to a consumer.

5. The method of claim 1, wherein each account profile does not include personally identifiable information.

6. The method of claim 1, further comprising:
receiving, by a receiving device, a request for a consumer group, wherein the request for a consumer group includes at least a spending behavior;
identifying, by the processing device, the scoring model based on the spending behavior; and
transmitting, by a transmitting device, at least the account data included in each account profile included in the subset of account profiles included in at least one account profile grouping.

7. The method of claim 6, wherein
the request for a consumer group further includes a geographic location, and
the at least one account profile grouping is based on the geographic location and the micro-neighborhood location identifier included in each account profile included in the subset of account profiles included in at least one account profile grouping.

8. The method of claim 6, further comprising:
generating, by the processing device, the scoring model based on the spending behavior included in the received request for a consumer group and the transaction data included in one or more transaction data entries included in one or more account profiles stored in the account database.

9. The method of claim 1, further comprising:
generating, by the processing device, the scoring model based on the transaction data included in one or more transaction data entries included in one or more account profiles stored in the account database.

10. The method of claim 1, wherein the score for each account profile indicates a propensity for the related consumer to spend for one or more of a plurality of spend criteria.

11. A system for generating a micro-neighborhood of consumers, comprising:
an account database configured to store a plurality of account profiles, wherein each account profile includes data related to a consumer including at least account data, a micro-neighborhood location identifier, and a plurality of transaction data entries, each transaction data entry being related to a payment transaction involving the related consumer and including at least transaction data; and
a processing device configured to
score each account profile stored in the account database by application of a scoring model to at least the transaction data included in one or more transaction data entries included in the respective account profile, and
identify a plurality of account profile groupings, wherein each account profile grouping includes a subset of the plurality of account profiles identified based on at least the score for and micro-neighborhood location identifier included in each account profile included in the subset, wherein
the subset of the plurality of account profiles included in each account profile grouping includes at least a predetermined number of account profiles.

12. The system of claim 11, wherein identifying a plurality of account profile groupings based on at least the score for and micro-neighborhood location identifier included in each account profile included in the subset is further based on application of one or more optimization algorithms to the score for each account profile included in the subset and a distance between each account profile included in the subset based on the included micro-neighborhood location identifier.

13. The system of claim 11, wherein the micro-neighborhood location identifier is at least one of: radius of a mile or less around a given latitude and longitude, and a plurality of blocks on one or more adjacent streets.

14. The system of claim 11, wherein the predetermined number of account profiles is a minimum number of account profiles such that no account profile included in the account profile grouping is personally identifiable to a consumer.

15. The system of claim 11, wherein each account profile does not include personally identifiable information.

16. The system of claim 11, further comprising:
a transmitting device; and
a receiving device configured to receive a request for a consumer group, wherein the request for a consumer group includes at least a spending behavior, wherein
the processing device is further configured to identify the scoring model based on the spending behavior, and
the transmitting device is configured to transmit at least the account data included in each account profile included in the subset of account profiles included in at least one account profile grouping.

17. The system of claim 16, wherein
the request for a consumer group further includes a geographic location, and
the at least one account profile grouping is based on the geographic location and the micro-neighborhood location identifier included in each account profile included in the subset of account profiles included in at least one account profile grouping.

18. The system of claim 16, wherein the processing device is further configured to generate the scoring model based on the spending behavior included in the received request for a consumer group and the transaction data included in one or more transaction data entries included in one or more account profiles stored in the account database.

19. The system of claim 11, wherein the processing device is configured to generate the scoring model based on the transaction data included in one or more transaction data entries included in one or more account profiles stored in the account database.

20. The system of claim 11, wherein the score for each account profile indicates a propensity for the related consumer to spend for one or more of a plurality of spend criteria.
